(19) United States
(12) Patent Application Publication
(10) Pub. No.: US 2011/0082745 A1
(43) Pub. Date: Apr. 7, 2011

(54) PORTABLE CONSUMER TRANSACTION PAYMENT DEVICE BEARING SPONSORED FREE SAMPLE

(76) Inventor: Stacy Pourfallah, Oakland, CA (US)

(21) Appl. No.: 12/573,817

(22) Filed: Oct. 5, 2009

(51) Int. Cl. G06Q 30/00; G06F 17/00

(52) U.S. Cl. 705/14.55; 235/380; 705/14.69; 235/492

(57) ABSTRACT

Information is received in a transmission from a network about a free sample in response to a request. The information includes an advertising account to which a merchant can charge the cost of the free sample provided to a consumer, and also an identifier and quantity of the free sample. The information is written to the memory of a portable consumer transaction payment device where, also encoded in the memory, is an account issued by an issuer to the consumer for the consumer to engage in transactions on the account with merchants in a payment processing network. Data from a transaction for the free sample is submitted by a merchant to its acquirer for processing by a transaction handler who requests payment for the transaction from the advertising account, and the issuer of the advertising account forwards the payment for the free sample to the merchant's acquirer to reimburse the merchant.

### CROSS-REFERENCE TO RELATED APPLICATIONS

The case is filed concurrently with U.S. patent application Ser. No. ______, by Stacy Pourfallah, titled “Portable Prescription Transaction Payment Device,” Attorney Docket No. P-14680US (930676.00326), with U.S. patent application Ser. No. ______, by Stacy Pourfallah, titled “Portable Consumer Transaction Payment Device Bearing Sample Prescription,” Attorney Docket No. P-14680US2 (930676.00412), with U.S. patent application Ser. No. ______, by Stacy Pourfallah, titled “Free Sample Account Transaction Payment Card Kiosk,” Attorney Docket No. P-14680US3 (930676.00413), and with U.S. patent application Ser. No. ______, by Stacy Pourfallah, titled “Prescription Sample Transaction Payment Card,” Attorney Docket No. P-14680US4 (930676.00414), each of which is incorporated herein by reference.

### FIELD

The present invention relates generally to the distribution of samples, and more particularly with the distribution of free samples, and most particularly to a distribution of a free sample in a transaction with a consumer's portable consumer transaction payment device used at a merchant to dispense to the consumer the free sample, the portable consumer transaction payment device being associated with the account of a sponsor who is financially response for the cost of the free sample.

### BACKGROUND

A merchant may desire to give its consumers a free sample of a product sold by a different, second merchant that may be of interest to that consumer. However, this form of distribution can be cumbersome and expensive. The first merchant needs to stock, maintain, and account for an inventory of the samples as well as continually replenish the depleting stock with on-going distribution of the samples. Furthermore, the need to safely and effectively package small quantities of product intended to be distributed as free samples increases the cost of providing the samples.

Thus, there is a need for a system that allows merchants to provide consumers with sample products that is both less cumbersome and more cost effective.

### SUMMARY

In one implementation, a method includes receiving, in a transmission from a network, information about a free sample in response to a request. The information includes an advertising account for a merchant to charge the cost of the free sample to and an identifier and quantity of the free sample. The information is written to the memory of a portable consumer transaction payment device where, also encoded in the memory, is a consumer account for the consumer to engage in transactions on the account with merchants in a payment processing network. A transaction for the free sample is submitted by the merchant to the merchant's acquirer for processing by a transaction handler who requests payment for the transaction from the advertising account, and the issuer of the advertising account forwards the payment for the free sample to the acquirer to reimburse the merchant. Other transactions, which are not for the free sample, are submitted by each merchant to an acquirer for processing by a transaction handler who requests payment for the transaction from the account borne on the portable consumer transaction payment device, and the issuer of the account forwards the payment to the acquirer to reimburse the merchant.

In another implementation, a method includes browsing to an Internet website in communication with a web service having a database of information that includes free samples and sending a request to the web service including a selection of one free sample. Information about the free sample is then received in a transmission from the website. The information includes an advertising account for a merchant to charge the cost of the free sample for payment to the merchants' account to reimburse the merchant for the free sample, a graphic image for rendering at a Point Of Service terminal (POS), and an identifier and quantity of the free sample. The received information is written to the memory of a portable consumer transaction payment device where, also encoded in the memory, is a consumer account for the consumer to engage in transactions on the account with merchants in a payment processing network. In a transaction between the consumer and a merchant for the free sample, data from the transaction is submitted by the merchant to the merchant's acquirer for processing by a transaction handler who requests payment for the transaction from the advertising account, and the issuer of the advertising account forwards the payment for the free sample to the merchant's acquirer to reimburse the merchant for giving the free sample to the consumer. Other transactions, which are not for the free sample, are submitted by each merchant to an acquirer for processing by a transaction handler who requests payment for the transaction from the account borne on the portable consumer transaction payment device, and the issuer of the account forwards the payment to the acquirer to reimburse the merchant.

In yet another implementation, an apparatus is presented. The apparatus includes a user interface to receive a request for a free sample and a network communication device to send the request for the free sample and receive an advertising account for a merchant to charge the cost of the free sample to in order to reimburse the merchant for the free sample. The apparatus further includes a card writer to encode data in the memory of the portable consumer transaction payment device where the data includes the advertising account, an identifier and quantity of the free sample, and a graphic image for rendering at a Point of Sale terminal (POS) of the merchant. Already encoded in the memory of the portable consumer transaction payment device is a consumer account for the consumer to engage in transactions on the account with merchants in a payment processing network. In a transaction between the consumer and a merchant for the free sample, data from the transaction is submitted by the merchant to the merchant's acquirer for processing by a transaction handler who requests payment for the transaction from the advertising account, and the issuer of the advertising account forwards the payment for the free sample to the merchant's acquirer to reimburse the merchant for giving the free sample to the consumer. Other transactions, which are not for the free sample, are submitted by each merchant to an acquirer for processing by a transaction handler who requests payment for the transaction from the account borne on the portable consumer transaction payment device, and the issuer of the account forwards the payment to the acquirer to reimburse the merchant.

The foregoing advantages will appear in the detailed description that follows. In the description, reference is made to the accompanying drawings.

### BRIEF DESCRIPTION OF THE DRAWINGS

Implementations of the invention will become more apparent from the detailed description set forth below when taken in conjunction with the drawings, in which like elements bear like reference numerals.

FIG. 1 depicts a block diagram of an exemplary method of a merchant provider using a card processor system to associate a portable consumer transaction payment device with an electronic voucher;

FIG. 2 illustrates possible alternative implementations of the data encoding area of a portable consumer transaction payment device capable of being associated with an electronic voucher for a sample;

FIG. 3 depicts the environment within FIG. 1 where a portable consumer transaction payment device is used by a consumer to obtain a sample; and

FIG. 4 depicts a flow chart of an exemplary method used by a transaction handler to process an electronic voucher stored on a portable consumer transaction payment device; and

FIG. 5 illustrates an exemplary payment processing network, depicting the general environment where a portable consumer transaction payment device may be used by a card holder to obtain a sample.

### DETAILED DESCRIPTION

The present discussion considers the distribution of a free sample, which can be a good and/or a service, by a consumer's use of a portable consumer transaction payment device which is used by a consumer to conduct a transaction for a free sample with a merchant. In the present context, an account for the payment of a sample attributable to an electronic voucher is issued by an issuer to a third-party sponsor of the electronic voucher and credited with funds submitted by the third-party. The funds are for reimbursement of the distribution of free samples by a retail merchant upon the presentation of the portable consumer transaction payment device having the electronic voucher stored thereon. As such, the portable consumer transaction payment device serves the consumer as; (i) a free sample card for the consumer to use to obtain a free sample from a merchant without paying for the free sample; and (ii) a typical card (i.e., credit card, debit card, or prepaid card, etc.) to use for other commercial transactions for which the consumer must pay the merchant from funds associated with an account issued to the consumer that corresponds to the card. Accordingly, the portable consumer transaction payment device will also be referred to herein as a ‘free sample card’.

In certain implementations, the sponsor of the electronic voucher is the manufacturer of the sample. In certain implementations, the merchant who provides data as input into the memory or storage of the sample card is a distributor of the sample. In certain implementations, the merchant provider is a wholesaler of the sample. In certain implementations, the merchant provider and the third-party sponsor are the same entity. In certain implementations, the merchant provider is a retailer of different goods or services than the retail merchant.

In certain implementations, the third-party sponsor, merchant provider, and/or retail merchant are related companies. In such implementations, the retail merchant and or merchant provider may be subsidiaries of the third-party sponsor.

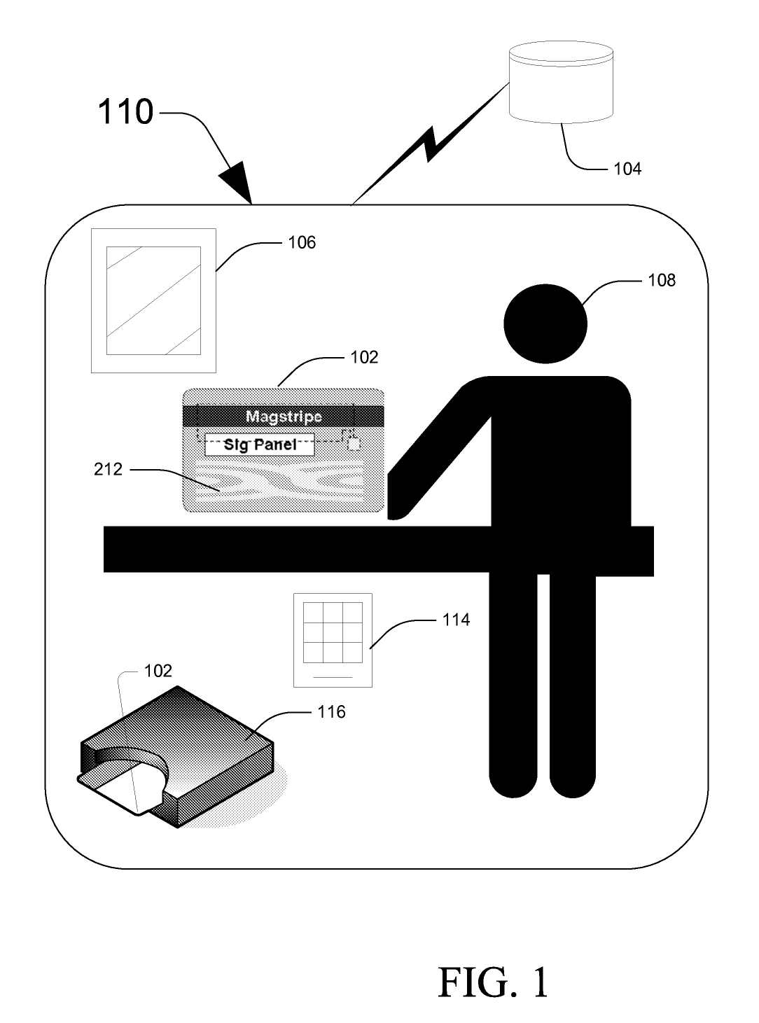

Turning now to FIG. 1, an exemplary block diagram is presented of an environment 110 of a merchant provider using a card processor system to associate a sample card with an electronic voucher for a free sample, where the sample card may be used by the consumer to obtain a sample from a second retail merchant and the sample card is a portable consumer transaction payment device. Although the implementation is discussed in regards to a substantially planar laminated card, one skilled in the art will recognize that other forms of transaction tokens could be used in the disclosed method.

Sample card 102, being a portable consumer transaction payment device, may be a credit card, debit card, prepaid card, loyalty card, or other such device associated with an account that was issued by an issuer to a consumer. Thus, the consumer may use sample card 102 to both receive a sample and to pay for an item or service. In certain implementations, the account of the consumer associated with sample card 102 is a regulated account that's use is limited to payments to certain kinds of merchants dealing in certain limited commodities, where such merchants may be represented by one or more Merchant Commodity Codes (i.e., petroleum products and services, travel and entertainment, healthcare, etc.) In certain implementations, the consumer account is a revolving credit account, a debit account, or a prepaid account. In certain implementations, the consumer account is a Flexible Savings Account (FSA), a Health Savings Account (HAS), or a Health Reimbursement Account (HRA).

In certain implementations, a card processor system is connected to a database 104. In certain implementations, database 104 is a database of electronic vouchers for free samples which merchant provider 108 may distribute to consumers. In one implementation, a third-party offering, and willing to pay for, the distribution of at least one sample using an electronic voucher has access to the database and may send to and receive from the database information such as the number of electronic vouchers used, the number of electronic vouchers remaining, alternatives to a given sample, or any other relevant information.

In certain implementations, database 104 is connected to a network accessible by a computer used by merchant provider 108. In such implementations, the network may be a Local Area Network (LAN), Wide Area Network (WAN), Personal Area Network (PAN), Virtual Private Network (VPN), Storage Area Network (WAN), Global Area Network (GAN), Internetwork, or combination thereof. In such implementations, the computer may connect to the network using wireless communications, optical fiber, Ethernet, ITU-T G.hn, or similar technology, or a combination thereof. In such implementations, the computer may include a network card, network adapter, or network interface controller (NIC). In other implementations, the computer may include other types of hardware capable of connecting to and communicating with a network.

In certain implementations, database 104 is provided by a web service in communication with a website. In such implementations, merchant provider 108 browses, using a web browser of a web-enabled computer, to the website to select an electronic voucher from database 104.

In certain implementations, database 104 also includes information relating to each electronic voucher stored therein. In such implementations, database 104 may include an identifier for the free sample and an account identifier of the third-party sponsor of the electronic voucher. In certain implementations, the account of the third-party sponsor is a regulated account that's use is limited to payments to healthcare providers. In certain implementations, the third-party account is a revolving credit account, a debit account, or a prepaid account. In certain implementations, the third-party account is a Flexible Savings Account (FSA), a Health Savings Account (HAS), or a Health Reimbursement Account (HRA).

In certain implementations, database 104 includes information regarding the number of samples eligible for distribution using the electronic voucher. By way of example and not limitation, the electronic voucher may be valid for three (3) sample-sized cans for house paint, or a free decal for an automobile body part, or a free massage at a spa, or a free tennis lesson, or a free appraisal of a jewelry or work of art, or for both a free car wash and a free air freshener. In certain implementations, database 104 includes information regarding a retail merchant where the electronic voucher is valid only for use with that particular retail merchant. In other implementations, the database 104 includes information regarding an expiration date, after which the electronic voucher is no longer valid.

In certain implementations, database 104 includes advertisements capable of being rendered as printed out on a hard copy or rendered on a monitor at a merchant POS when the sample card bearing the electronic voucher is presented to a retail merchant. In certain implementations, a specific advertisement is selected by merchant provider 108 to be associated with the sample card. In certain implementations, the advertisements are pre-associated with the electronic vouchers. In certain implementations, the advertisement may be an image. In certain implementations, the advertisement may be for a type of good or service, which may or may not be related to the free sample. In certain implementations, the advertisement may be for the merchant providing the free sample for the third-party sponsor. In certain implementations, the advertisement is of a different good or service provided by merchant provider 108, the retail merchant, or by the third-party sponsor. In certain implementations, the advertisement is for a merchant, or a good or service provided by a merchant, who's retail location is near merchant provider 108 or the retail merchant.

In some implementations, database 104 includes information regarding a coupon for a free or discounted item. The coupon may be issued by the third-party sponsor of the electronic voucher and may be pre-associated with the electronic voucher selected by merchant provider 108. In other implementations, merchant provider 108 may select a coupon from multiple coupons available in database 104. In yet other implementations, database 104 may automatically associate coupons with particular electronic vouchers. The association may be based upon the sample, the consumer, or any other criteria. In one implementation the coupon expires with the use of the sample card, the discount only being redeemable at the time the sample is dispensed. In other implementations, the coupon is redeemable at a later time.

In certain implementations, the identifier of the free sample corresponds to a type of good or service. In certain implementations, the identifier is an image capable of being displayed or printed by a merchant POS. In certain implementations, the identifier of the free sample is a Stock Keeping Unit (SKU). In certain implementations, the identifier of the free sample is a Universal Product Code (UPC). In certain implementations, the identifier is of a trademark associated with the product being distributed as a sample, the trade name of the wholesaler of the product, or the trade name of the manufacturer of the product. In certain implementations, the identifier is for an active ingredient of the product being distributed as a free sample.

The card processor system, in some implementations, may include a user interface 106 capable of presenting merchant provider 108 with a selection of electronic vouchers available for distribution. The user interface 106 may be a touch screen, a digital electronic display, a projector, a monitor, any combination of the foregoing, or any other device for the presentation of information.

Merchant provider 108 may select an electronic voucher using input device 114. Input device 114 may be a key pad, a touch screen, a pointing device, an audio input device, a video input device, any combination of the foregoing, or other hardware capable of receiving and transforming data for use by the device.

Card read-write device 116 may then be used to associate the selected electronic vouchers with sample card 102, wherein sample card 102 is a portable consumer transaction payment device associated with a financial account of a consumer and can be used to conduct transactions for goods or services with various merchants. Card read-write device 116 stores information relating to the electronic voucher selected by merchant provider 108 on sample card 102, including the account identifier associated with an account of the third-party sponsor of the electronic voucher, an identifier of the sample product to be distributed, and a quantity to be distributed.

In certain implementations, the electronic voucher may be for a sample made by a particular manufacturer. In such an implementation, the electronic voucher may be valid for a sample of all products made by that manufacturer. In certain implementations, the electronic voucher may be for a sample of a particular type of product made by the manufacturer. In such an implementation, the electronic coupon may be valid for a sample of a particular class of items.

In certain implementations, card read-write device 116 stores additional information on sample card 102. Wherein the electronic voucher is for a sample of a particular item, card read-write device 116 may additionally store, by way of example and not limitation, identifiers for the merchant provider 108, an identifier for the consumer, and the item for which a sample is to be provided.

In certain implementations, card read-write device 116 is a memory card reader. In such an implementation, sample card 102 is a smart card and the account identifier and any additional information is stored in the memory of an embedded chip. In certain implementations, sample card 102 is a contact smart card having a contact area that when inserted into card read-write device 116 makes contact with electrical connectors capable of writing the information to memory. In certain implementations, sample card 102 is a contactless smart card in which the chip communicates with card read-write device 116 through radio-frequency identification (RFID) induction technology.

In certain implementations, card read-write device 116 is a magnetic card reader. In such an implementation, sample card 102 has a magnetic data stripe. The account identifier and any additional information is stored on sample card 102 when the magnetic data stripe is placed in physical contact with a read-write head of card read-write device 116. In certain implementations, sample card 102 includes both an embedded chip and a magnetic stripe.

In one implementation, sample card 102 may also include an image 112 printed on a surface. Image 112 may be preprinted on sample card 102 by the third-party sponsor and may serve as an advertisement. Alternatively, image 112 may be printed by the card processor and may present usage instructions for the free sample. In such cases, the consumer to whom the portable consumer transaction payment device belongs would likely be required to give consent to a merchant before allowing their device to be imprinted with an advertisement and the like. Further, sample card 102 may display a flat or raised account number as well as the sample product name, quantity, instructions, consumer name, and any other relevant information.

Wherein the card processor system is capable of printing image 112 on sample card 102, the device may include a card printer such as, for example, the Direct-to-Card (DTC) 550 or High Definition Printing (HDP) 5000 commercially available from Fargo Electronics, Inc., a corporation located in Eden Prairie, Minn.

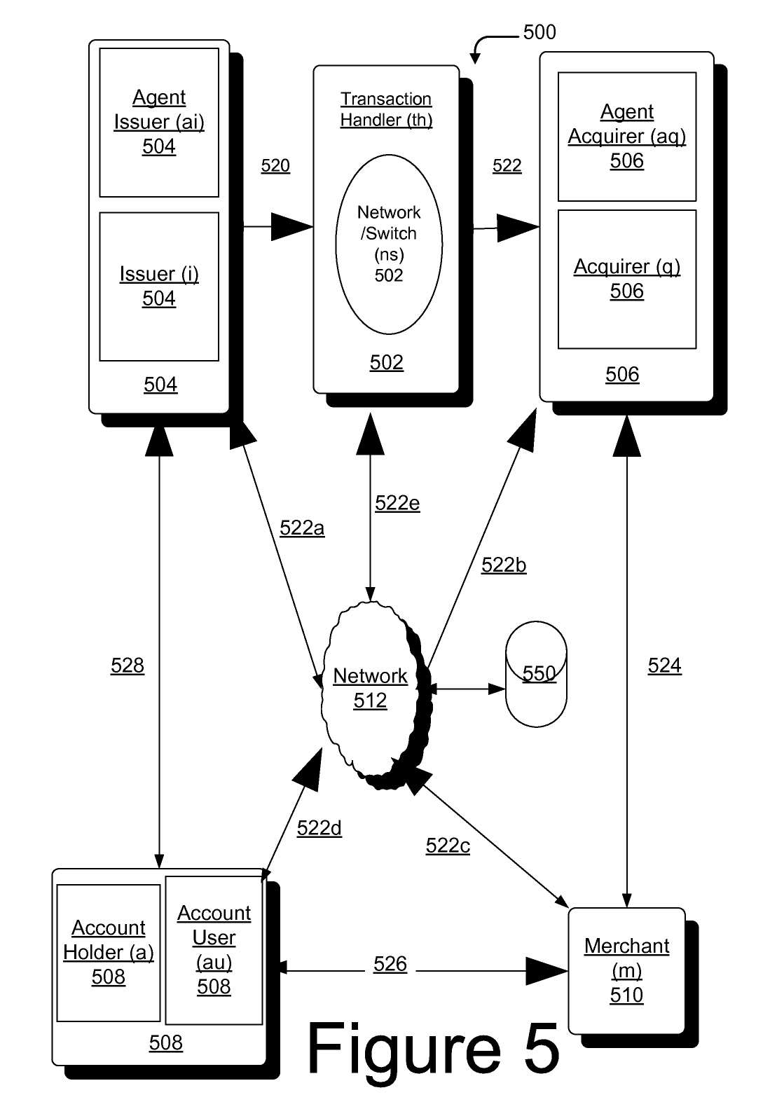

In certain implementations, the card processor system is also used to associate the electronic voucher selected by merchant provider 108 and sample card 102. In such implementations, a transaction handler, such as transaction handler (th) 502 (FIG. 5), or another party who manages free sample sponsor accounts, receives the account identifier associated with an account of the third-party sponsor of the electronic voucher and an identifier of the sample card 102 via the card processor system. In certain implementations, additional information regarding the specific electronic voucher stored on sample card 102 is also included.

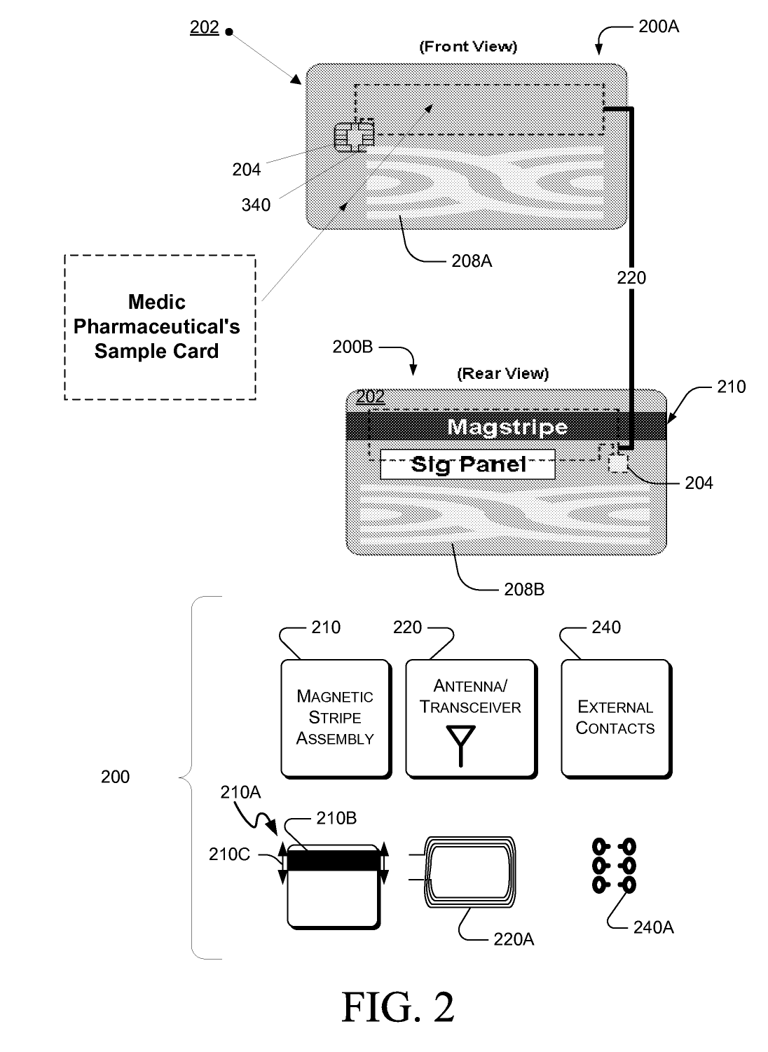

Turning to FIG. 2, both a front view 200A and a rear view 200B of an exemplary portable consumer transaction payment device 202 are presented. Images may be displayed on both sides of portable consumer transaction payment device 202, with image 208A on the front view 200A being either the same as or different from image 208B on the rear view 200B. In this illustration, the front view 200A also displays information about the provider of portable consumer transaction payment device 202.

FIG. 2 also shows exemplary implementations of a data encoding area of portable consumer transaction payment device 202. The data encoding area may include an optional shielding element, which allows desired electromagnetic, optical, or radiative signals to penetrate while protecting the data encoding area from physical abuse or damage. Portable consumer transaction payment device 202 may optionally have areas outside of the data encoding area shielded from physical abuse or otherwise acceptable forms of electromagnetic radiation. Some of the acceptable signals that are allowed to penetrate the shielding and may include, but are not limited to, signals accompanying a magnetic field, RFID signals, IrDA signals, visible light, invisible light, modulated laser, and/or modulated RF communication signals. By way of example and not limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 200, and include a magnetic stripe assembly 210, an antenna and/or transceiver 220, and electrical contacts 240. Magnetic stripe assembly 210 may comprise, in the implementation shown as 210A, a reprogrammable magnetic stripe assembly 210B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of assembly 210, rendering the card useless in the event of its loss or theft. In the implementation shown as 210A, magnetic stripe assembly 210B at least partially slidably moves 210C into and out of an assembly of portable consumer transaction payment device 202 (partial view shown), allowing portable consumer transaction payment device 202 to conduct a transaction at a point of sale terminal that includes a magnetic stripe reader.

Continuing with FIG. 2, another implementation of the data encoding area is shown as an antenna and/or transceiver 220. Antenna and/or transceiver 220 may include commonly used loop inductors such as the one shown 220A or in those shown in related ISO standards for RF-readable smart cards. With such an interface, account data may be translated, modulated and transmitted in a manner acceptable by an RF contactless merchant POS terminal, a 802.11 WiFi or WiMax network, or by a cellular or RF communications network. For instance, antenna and/or transceiver 220 may receive a wireless communication from a card read-write device, where the wireless communication carries data for a sponsor's electronic voucher account that is to be written in memory to the data encoding area 200.

Electrical contacts 240 are yet another alternative implementation of the data encoding area shown in FIG. 2. With portable consumer transaction payment device 202 possessing physical contacts such as an array of conductive pads or shapes 240A, portable consumer transaction payment device 202 may be placed in physical contact with a merchant POS terminals, and electrical contacts 240 may establish connectivity between imbedded integrated circuit 204 and the merchant's financial processing system. The processor may relay account-related information to the merchant POS terminal through the contact interface, thereby allowing portable consumer transaction payment device 202 to be utilized with the large number of preexisting merchant POS terminals.

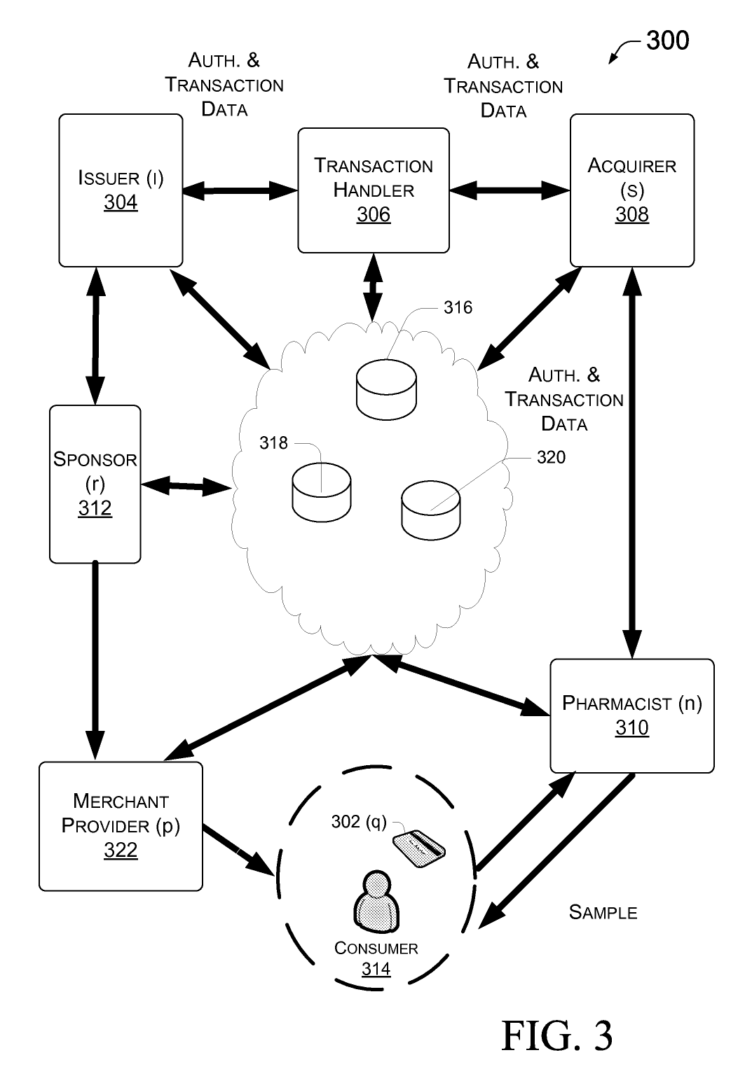

Within the exemplary payment processing system depicted in FIG. 5, FIG. 3 illustrates the general environment wherein a portable consumer transaction payment device, such as portable consumer transaction payment device 202 (FIG. 2) associated with an electronic voucher as seen in connection with FIG. 1, is used by a consumer to receive a sample from a retail merchant. To start, at the POS terminal of retail merchant 310, consumer 314 presents to retail merchant 310 both a free sample and their portable consumer transaction payment device 302. The consumer 314, in addition to the free sample, may also present another good or service that the consumer 314 wishes to pay for.

To begin the transaction for the free sample, and optionally for other goods and services that the consumer 314 wishes to purchase, the retail merchant 310 uses a card reader associated with the POS terminal to read the information stored on portable consumer transaction payment device 302, including the account identifier associated with electronic voucher sponsor 312. In certain implementations, portable consumer transaction payment device 302 is read by swiping portable consumer transaction payment device 302 through the POS terminal to read data magnetically encoded in its magnetic stripe. In other implementations, the POS terminal reads portable consumer transaction payment device 302 using a contactless technology, such as RFID, when consumer 314 is near the POS terminal. In yet other implementations, to be read, portable consumer transaction payment device 302 is inserted into the POS terminal such that external contacts on portable consumer transaction payment device 302 establish connectivity with the POS terminal.

In certain implementations, other information is also read from portable consumer transaction payment device 302, such as, by way of example and not limitation, an expiration date, a sample type, or consumer 314's name. In such implementations, the POS terminal may determine whether the electronic voucher is valid for the free sample presented by the consumer 314. This may occur, by way of example and not limitation, by comparing the current date with the expiration data of the electronic voucher, or a Stock Keeping Unit (SKU), a Universal Product Code (UPC), or other data embedded in memory of the portable consumer transaction payment device 302.

In certain implementations, consumer 314 is requested to present identification. In such an implementation, the identification may be checked against a consumer identifier read from portable consumer transaction payment device 302 in order to verify that consumer 314 was the same consumer who was given portable consumer transaction payment device 302 from merchant provider 322. Alternatively, the identification may be used to verify that the individual presenting portable consumer transaction payment device 302 is authorized to receive the sample on behalf of consumer 314, such as in the case of a parent or spouse of consumer 314.

Upon receipt of portable consumer transaction payment device 302, the transaction is processed similarly to that previously described in connection with FIG. 1. Retail merchant 310 submits an authorization request to acquirer 308, which includes an account identifier associated with the electronic voucher stored on portable consumer transaction payment device 302. In certain implementations where consumer is also making a purchase of a good or a service, an account identifier of a financial account issued by an issuer to consumer 314 and associated with portable consumer transaction payment device 302 is also included in the authorization request.

In certain implementations, the authorization request is for only some of the samples or amounts described by the electronic voucher associated with portable consumer transaction payment device 302. In such an implementation, retail merchant 310 can send the authorization request only for the types or amounts of samples retail merchant 310 is capable of distributing at that time. In such a situation, consumer 314 could then use portable consumer transaction payment device 302 at another retail merchant to receive the rest of the sample associated with the electronic voucher stored on the card.

Where acquirer 308 is not the same entity as the issuer of the account associated with the electronic voucher read from portable consumer transaction payment device 302, acquirer 308 forwards the transaction information pertaining to the sample to a transaction handler 306, who in turn forwards it to issuer 304 to verify that the account associated with electronic voucher sponsor 312 contains sufficient funds to reimburse retail merchant 310 for the sample.

Upon receipt of a reply from issuer 304, transaction handler 306 forwards an authorization response regarding the free sample to acquirer 308, who forwards it to retail merchant 310. Where the authorization response contains an approval of the use of the electronic voucher, consumer 314 is given the associated sample free of charge.

In certain implementations, the authorization response is only a partial response. In such implementations, the authorization request may have included types of samples or amounts not associated with the account identifier of the electronic voucher stored on portable consumer transaction payment device 302. Alternatively, in such implementations, the authorization request may have included items consumer 314 wishes to purchase using a financial account belonging to consumer 314 and associated with portable consumer transaction payment device 302.

In certain implementations, retail merchant 310 invalidates or deletes the electronic voucher(s) stored on portable consumer transaction payment device 302 once the sample has been provided to consumer 314. In certain implementations, the electronic voucher(s) are invalidated or deleted only after all of the samples described in the sample information have been redeemed by consumer 314. In such an implementation, consumer 314 may fill only part of the sample at a given time or may receive portions of the samples from different retail merchants.

In certain implementations, retail merchant 310 further prints an advertisement or a coupon stored on portable consumer transaction payment device 302 and provides the advertisement or coupon to consumer 314.

In certain implementations, approval of the transaction may be more involved. In such implementations, the authorization request includes additional information, by way of example and not limitation, the sample to be distributed, the merchant provider, the retail merchant, and/or the sponsor of the electronic voucher. In one implementation, database 316 may be used to, by way of example and not limitation, to verify that electronic voucher sponsor 312 has issued the electronic voucher consumer 314 is attempting to use. In such an implementation, the authorization process may include comparing the additional information provided against information stored in database 316. In other implementations, database 316 is used to keep a tally of the electronic vouchers used by consumers. In such an implementation, this information may then be used by electronic voucher sponsor 312 in deciding future electronic vouchers to issue or for identifying specific consumers for targeted advertising. In still other implementations, the additional information includes the identifier for the advertisement that was presented to consumer 314 with the electronic voucher being used, such as the advertisement on sample card 302. In such an implementation, the electronic voucher sponsor 312 may charge another entity a fee for each time the advertisement has been presented with the electronic voucher.

In other implementations, database 318 is used. Database 318 may contain information regarding the account issued to each electronic voucher sponsor 312(r), where electronic voucher sponsor 312(r) is one of up to ‘R’ electronic voucher sponsors. In such implementations, database 318 may be used to verify that the account identifier read from sample card 302 is associated with one of the ‘R’ electronic voucher sponsors. Database 318 may additionally be used to verify that the associated account contains sufficient funds with which to reimburse retail merchant 310 for the sample distributed.

In yet another implementation, another database 320, contains information regarding all activated sample cards, wherein merchant provider 322 activates sample card 302 prior to giving it to consumer 314. Alternatively, a representative of electronic voucher sponsor 312 may activate sample card 302 prior to providing it to merchant provider 322. Approval of the transaction request may, in such an implementation, depend upon verification that sample card 302 is activated.

Once the authorization request is approved and the sample associated with the electronic voucher stored on portable consumer transaction payment device 302 is distributed, retail merchant 310 may submit a payment request to payment processing system 300 for reimbursement from electronic voucher sponsor 312's account for the cost of the sample. Specifically, retail merchant 310 submits a request for payment to acquirer 308. Where acquirer 308 is not the same entity as the issuer of the account associated with the account identifier stored on portable consumer transaction payment device 302, acquirer 308 forwards the request to transaction handler 306. Transaction handler 306 in turn requests payment for the sample from issuer 304, where issuer 304 is the issuer of the account associated with electronic voucher sponsor 312. Issuer 304 debits the account associated with electronic voucher sponsor 312 and forwards the payment to transaction handler 306 who forwards the payment to acquirer 308. Finally, acquirer 308 credits the account of retail merchant 310 for the cost of the distributed sample.

As will be understood by a person of ordinary skill in the art, the process described in connection with FIG. 3 is equally applicable to the situation where a consumer uses a portable consumer transaction payment device having multiple electronic vouchers stored thereon to receive several different samples. In such a situation, the electronic vouchers may be provided by different electronic voucher sponsors having accounts issued by different issuers. Further, it will be clear to a person of ordinary skill in the art that a portable consumer transaction payment device may have multiple electronic vouchers stored thereon that are valid at different retail merchants, each having a different acquirer.

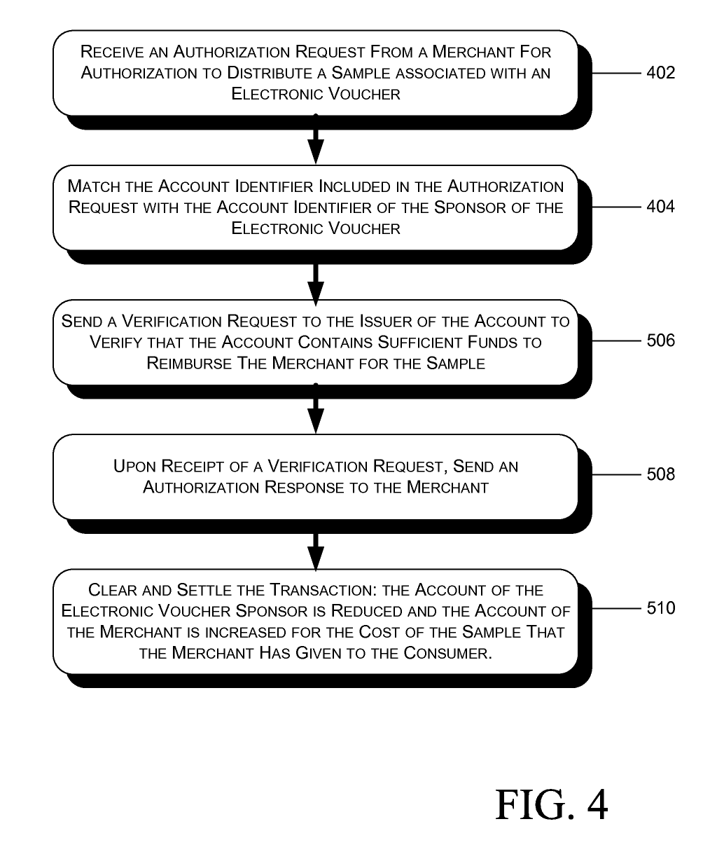

Turning now to FIG. 4, a flow chart of an exemplary method used by a transaction handler to process an electronic voucher stored on a portable consumer transaction payment device is presented. As indicated by block 402, the transaction handler (or other agent for a sponsor) receives an authorization request from a retail merchant via the merchant's acquirer, requesting authorization to distribute a sample associated with an electronic voucher to a consumer. Upon receipt of the request, the transaction handler matches the account identifier included in the request with the account identifier associated with the electronic voucher sponsor, as indicated by block 404. In certain implementations, if the account identifier included in the request does not match the account identifier associated with the electronic voucher sponsor, the transaction handler sends an authorization response to the retail merchant denying the distribution of the sample. In such an implementation, the process may end.

In the illustrated implementation of FIG. 4, the transaction handler, after receipt of an authorization request from the merchant's acquirer, next sends a request to the issuer of the account associated with the electronic voucher sponsor requesting verification that the account contains sufficient funds to reimburse the retail merchant for the sample, as indicated by block 406. As indicated by block 408, upon receipt of a response from the issuer, the transaction handler sends a response to the retail merchant via the merchant's acquirer. Where the issuer confirms that the account contains sufficient funds, the authorization request may contain an approval. Finally, as indicated by block 410, the transaction handler clears and settles the transaction by facilitating a process in which the issuer debits the account of the electronic voucher sponsor and an acquirer for the merchant credits the merchant's account for the cost of the free sample that the merchant dispensed to the consumer.

In certain implementations, individual blocks described above may be combined, eliminated, or reordered. In certain implementations, instructions are encoded in computer readable medium wherein those instructions are executed by a processor to perform one or more of the blocks 402, 404, 406, 408, and 410 recited in FIG. 4. In yet other implementations, instructions reside in any other computer program product, where those instructions are executed by a computer external to, or internal to, a computing system to perform one or more of the blocks 402, 404, 406, 408, and 410 recited in FIG. 4. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

An Exemplary Transaction Processing System

Referring to FIG. 5, a transaction processing system 500 is seen. The general environment of FIG. 5 include that of a merchant (m) 510, such as the merchant, who can conduct a transaction for goods and/or services with an account user (au) (e.g., consumer) on an account issued to an account holder (a) 508 by an issuer (i) 504, where the processes of paying and being paid for the transaction are coordinated by at least one transaction handler (th) 502 (e.g., the transaction handler) (collectively “users”). The transaction includes participation from different entities that are each a component of the transaction processing system 500.

The transaction processing system 500 may have at least one of a plurality of transaction handlers (th) 502 that includes transaction handler (1) 502 through transaction handler (TH) 502, where TH can be up to and greater than an eight digit integer.

The transaction processing system 500 has a plurality of merchants (m) 510 that includes merchant (1) 510 through merchant (M) 510, where M can be up to and greater than an eight digit integer. Merchant (m) 510 may be a person or entity that sells goods and/or services. Merchant (m) 510 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 508 may be a second merchant (m) 510 making a purchase from another merchant (m) 510.

Transaction processing system 500 includes account user (1) 508 through account user (AU) 508, where AU can be as large as a ten digit integer or larger. Each account user (au) conducts a transaction with merchant (m) 510 for goods and/or services using the account that has been issued by an issuer (i) 504 to a corresponding account holder (a) 508. Data from the transaction on the account is collected by the merchant (m) 510 and forwarded to a corresponding acquirer (a) 506. Acquirer (a) 506 forwards the data to transaction handler (th) 502 who facilitates payment for the transaction from the account issued by the issuer (i) 504 to account holder (a) 508.

Transaction processing system 500 has a plurality of acquirers (q) 506. Each acquirer (q) 506 may be assisted in processing one or more transactions by a corresponding agent acquirer (aq) 506, where ‘q’ can be an integer from 1 to Q, where aq can be an integer from 1 to AQ, and where Q and AQ can be as large as a eight digit integer or larger. Each acquirer (q) 506 may be assisted in processing one or more transactions by a corresponding agent acquirer (aq) 506, where ‘q’ can be an integer from 1 to Q, where aq can be an integer from 1 to AQ, and where Q and AQ can be as large as a eight digit integer or larger.

The transaction handler (th) 502 may process a plurality of transactions within the transaction processing system 500. The transaction handler (th) 502 can include one or a plurality or networks and switches (ns) 502. Each network/switch (ns) 502 can be a mainframe computer in a geographic location different than each other network/switch (ns) 502, where ‘ns’ is an integer from one to NS, and where NS can be as large as a four digit integer or larger.

Dedicated communication systems 520, 522 (e.g., private communication network(s)) facilitate communication between the transaction handler (th) 502 and each issuer (i) 504 and each acquirer (a) 506. A Network 512, via e-mail, the World Wide Web, cellular telephony, and/or other optionally public and private communications systems, can facilitate communications 522a-522e among and between each issuer (i) 504, each acquirer (a) 506, each merchant (m) 510, each account holder (a) 508, and the transaction handler (th) 502. Alternatively and optionally, one or more dedicated communication systems 524, 526, and 528 can facilitate respective communications between each acquirer (a) 506 and each merchant (m) 510, each merchant (m) and each account holder (a) 508, and each account holder (a) 508 and each issuer (i) 504, respectively.

The Network 512 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 512 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 512 may utilize any of a variety of communication protocols, such as Transmission Control Protocol/Internet Protocol (TCP/IP), for example. There may be multiple nodes within the network 512, each of which may conduct some level of processing on the data transmitted within the transaction processing system 500.

Users of the transaction processing system 500 may interact with one another or receive data about one another within the transaction processing system 500 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 500 by the account holder (a) 508 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 508's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 510 may utilize at least one POI terminal (e.g., Point of Service or browser enabled consumer cellular telephone); that can communicate with the account user (au) 508, the acquirer (a) 506, the transaction handler (th) 502, or the issuer (i) 504. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 510 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 500.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 510. These data can include an account identifier of a healthcare account. In another example, the POI may be the PCD of the consumer, such as the cellular telephone of the consumer, where the merchant (m) 510, or an agent thereof, receives the account identifier of the consumer via a webpage of an interactive website rendered by a browser executing on a World Wide Web (Web) enabled PCD.

Typically, a transaction begins with account user (au) 508 presenting the portable consumer device to the merchant (m) 510 to initiate an exchange for resources (e.g., a good or service). The portable consumer device may be associated with an account (e.g., a credit account) of account holder (a) 508 that was issued to the account holder (a) 508 by issuer (i) 504.

Merchant (m) 510 may use the POI terminal to obtain account information, such as a number of the account of the account holder (a) 508, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 504 of the account associated with the PCD. Alternatively, or in combination, the PCD may communicate with issuer (i) 504, transaction handler (th) 502, or acquirer (a) 506.

Issuer (i) 504 may authorize the transaction and forward same to the transaction handler (th) 502. Transaction handler (th) 502 may also clear the transaction. Authorization includes issuer (i) 504, or transaction handler (th) 502 on behalf of issuer (i) 504, authorizing the transaction in connection with issuer (i) 504's instructions such as through the use of business rules. The business rules could include instructions or guidelines from the transaction handler (th) 502, the account holder (a) 508, the merchant (m) 510, the acquirer (a) 506, the issuer (i) 504, a related financial institution, or combinations thereof. The transaction handler (th) 502 may, but need not, maintain a log or history of authorized transactions. Once approved, the merchant (m) 510 may record the authorization, allowing the account user (au) 508 to receive the good or service from merchant (m) or an agent thereof.

The merchant (m) 510 may, at discrete periods, such as the end of the day, submit a list of authorized transactions to the acquirer (a) 506 or other transaction related data for processing through the transaction processing system 500. The transaction handler (th) 502 may optionally compare the submitted authorized transaction list with its own log of authorized transactions. The transaction handler (th) 502 may route authorization transaction amount requests from the corresponding the acquirer (a) 506 to the corresponding issuer (i) 504 involved in each transaction. Once the acquirer (a) 506 receives the payment of the authorized transaction from the issuer (i) 504, the acquirer (a) 506 can forward the payment to the merchant (m) 510 less any transaction costs, such as fees for the processing of the transaction. If the transaction involves a debit or pre-paid card, the acquirer (a) 506 may choose not to wait for the issuer (i) 504 to forward the payment prior to paying merchant (m) 510.

There may be intermittent steps in the foregoing process, some of which may occur simultaneously. For example, the acquirer (a) 506 can initiate the clearing and settling process, which can result in payment to the acquirer (a) 506 for the amount of the transaction. The acquirer (a) 506 may request from the transaction handler (th) 502 that the transaction be cleared and settled. Clearing includes the exchange of financial information between the issuer (i) 504 and the acquirer (a) 506 and settlement includes the exchange of funds. The transaction handler (th) 502 can provide services in connection with settlement of the transaction. The settlement of a transaction includes depositing an amount of the transaction settlement from a settlement house, such as a settlement bank, which transaction handler (th) 502 typically chooses, into a clearinghouse bank, such as a clearing bank, that acquirer (a) 506 typically chooses. The issuer (i) 504 deposits the same from a clearinghouse bank, such as a clearing bank, which the issuer (i) 504 typically chooses, into the settlement house. Thus, a typical transaction involves various entities to request, authorize, and fulfill processing the transaction.

The transaction processing system 500 will preferably have network components suitable for scaling the number and data payload size of transactions that can be authorized, cleared and settled in both real time and batch processing. These include hardware, software, data elements, and storage network devices for the same. Examples of transaction processing system 500 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 502 can include one or more data centers for processing transactions, where each transaction can include up to 100 kilobytes of data or more. The data corresponding to the transaction can include information about the types and quantities of goods and services in the transaction, information about the account holder (a) 508, the account user (au) 508, the merchant (m) 510, tax and incentive treatment(s) of the goods and services, coupons, rebates, rewards, loyalty, discounts, returns, exchanges, cash-back transactions, etc.

By way of example, network/switch (ns) 502 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 504 (or agent issuer (ai) 504 thereof) and each acquirer (a) 506 (or agent acquirer (aq) 506 thereof) can use or more router/switch (e.g., Cisco™ routers/switches) to communicate with each network/switch (ns) 502 via dedicated communication systems.

Transaction handler (th) 502 can store information about transactions processed through transaction processing system 500 in data warehouses such as may be incorporated as part of the plurality of networks/switches 502. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 500 over paying and being paid by cash, or other traditional payment mechanisms.

The VisaNet® system is an example component of the transaction handler (th) 502 in the transaction processing system 500. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 20 million merchants (m) 510. In 2007, around 71 billion transactions for about 4 trillion U.S. dollars were cleared and settled through the VisaNet® system, some of which involved a communication length of around 24,000 miles in around two (2) seconds.

In certain implementations, individual steps to be described in relation to FIG. 5 may be combined, eliminated, or reordered. In certain implementations, instructions are encoded in computer readable medium wherein those instructions are executed by a processor to perform one or more of the functions described below in connection with FIG. 5. In yet other implementations, instructions reside in any other computer program product, where those instructions are executed by a computer external to, or internal to, a computing system to perform one or more of the functions described below in connection with FIG. 5. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

The following example is presented to further illustrate to persons skilled in the art how to make and use the invention. This example is not intended as a limitation, however, upon the scope of the invention, which is defined only by the appended claims.

### Example

By way of example and not limitation, a manufacturer may decide to make vouchers available to its distributor for a sample of a product sold by a retail merchant, where the vouchers are to be given to potential consumers according to the present discussion. Through the use of a card processor system, distributor can determine whether he or she has available electronic vouchers for samples of the product to distribute and, if so, can request that a portable consumer transaction payment device associated with a financial account of a consumer also be associated with at least one such electronic voucher. The request may include a specific number of samples for distribution and a coupon for a discount on another product made by the manufacturer. The request is received by a transaction handler who associates the account identifier of the portable consumer transaction payment device with the electronic voucher information.

The distributor may additionally use the card processor system to store information relating to the sample, distributor, retail merchant, consumer, instructions, and any other information on the portable consumer transaction payment device via a magnetic stripe, imbedded microchip, or other method.

Once done, the consumer then presents the portable consumer transaction payment device to the retail merchant to redeem the samples. The retail merchant may require the consumer to show identification, such as a driver's license, to compare with information printed or stored on the portable consumer transaction payment device. The retail merchant then sends an authorization request for permission to dispense the sample and to charge the manufacturer's account. The authorization request is, for example, received by the retail merchant's acquirer who forwards it for processing by a transaction handler.

The transaction handler may then send an authorization response authorizing the distribution of the samples after matching the account identifier of the portable consumer transaction payment device originally provided by the distributor with the account identifier of the card presented to the retail merchant. Upon receiving the authorization response, the retail merchant may then distribute the approved quantity of the sample to the consumer. The transaction handler may also send a request to the issuer of the sample card to debit the manufacturer's account for the cost of the samples and forward that payment to the acquirer for deposit in the retail merchant's account.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising a plurality of steps each being performed by a computing apparatus executing software, wherein the computing apparatus is enabled for network communications, and wherein the steps include:
receiving in a transmission from the network, in response to a request sent over the network, information about a free sample that includes:
an advertising account for a merchant to charge the cost of the free sample for payment to a merchant account to reimburse the merchant for the free sample; and
an identifier and quantity of the free sample;
and
writing the received information to memory of a portable consumer transaction payment device, wherein:
the memory of the portable consumer transaction payment device has encoded therein a consumer account for the consumer to engage in a plurality of transactions on the consumer account with a plurality of said merchants in a payment processing network; and
each said transaction in the payment processing network is submitted by the merchant to an acquirer for processing by a transaction handler who requests an issuer of the account upon which the transaction was conducted to obtain payment for the transaction from the account, and wherein the issuer of the account forwards the payment for the transaction to the transaction handler who forwards the payment for the transaction to the acquirer to reimburse the merchant for the transaction.

2. The method as defined in claim 1, wherein the identifier of the free sample corresponds to a selection from the group consisting of:
a type of a commodity of a good or service;
a Stock Keeping Unit (SKU);
a Universal Product Code (UPC);
a trademark;
a trade name of a wholesaler;
a trade name of a manufacturer;
an active ingredient of the type of the commodity of the good or service; and
a combination of the foregoing.

3. The method as defined in claim 1, wherein the received information further comprises an advertisement selected from the group consisting of:
an advertisement for a type of a commodity of a good or service;
an advertisement for one said merchant retailing the commodity;
an advertisement for a provider of the commodity;
an advertisement for a different said commodity also provided the provider of the commodity;
an advertisement for a different said commodity also retailed by the merchant; and
an advertisement for a different said merchant having a retail location proximal to the merchant.

4. The method as defined in claim 1, wherein the consumer account of the portable consumer transaction payment device and the advertising account are different accounts each of which is a type of account selected from the group consisting of:
an account of regulated limited use for payments to healthcare providers;
a revolving credit account;
a debit account;
a prepaid account;
a Flexible Saving Account (FSA) card account;
a Health Saving Account (HAS) card account;
a Health Reimbursement Account (HRA) card account; and
a combination of the foregoing.

5. The method as defined in claim 1, wherein the writing to the memory further includes writing to the memory an image corresponding to the free sample.

6. The method as defined in claim 5, wherein the image is selected from the group consisting of:
an advertisement for the free sample;
an advertisement for the manufacturer of the free sample;
an offer of a discount on a purchase of the good or service corresponding to the free sample; and
a combination of the foregoing.

7. The method as defined in claim 1, wherein the memory of the portable consumer transaction payment device is selected from the group consisting of:
a non-volatile memory of a semiconductor device;
a magnetic encoded data region of a magnetic stripe; and
a combination of the foregoing.

8. The method as defined in claim 1, wherein the portable consumer transaction payment device is selected from the group consisting of:
a card having a Radio Frequency Identification (RFID) tag, a transponder device and a microchip; and
a magstripe card; and
a combination of the foregoing.

9. The method as defined in claim 1, wherein the writing to the memory of the portable consumer transaction payment device is performed by a step selected from the group consisting of:
transmitting data wirelessly to the portable consumer transaction payment device;
transmitting data via a hardwired communication to the portable consumer transaction payment device; and
magnetically encoding track data by modifying the magnetism of magnetic particles on a band of magnetic material on the portable consumer transaction payment device.

10. The method as defined in claim 1, wherein the network comprises the Internet and the method further comprises, prior to the receiving:
browsing to an Internet website in communication with a web service having a database of information that includes a plurality of different said free samples; and
sending the request to the web service, wherein the request includes a selection of the free sample.

11. The method as defined in claim 1, wherein data written to memory of the portable consumer transaction payment device further comprises an identifier and quantity of a plurality of other said free samples and their respective said advertising accounts.

12. A method comprising a plurality of steps each being performed by a web enabled computing apparatus by executing software, wherein the steps include:
browsing to an Internet website in communication with a web service having a database of information that includes a plurality of different free samples;
sending a request to the web service, wherein the request includes a selection of one said free sample;
receiving in a transmission from the web service, in response to the request, information about the one said free sample that includes:
an advertising account for a merchant to charge the cost of the one said free sample for payment to a merchant account to reimburse the merchant for the one said free sample;
a graphic image for rendering at a Point Of Service terminal (POS) of the merchant; and
an identifier and quantity of the one said free sample; and
writing the received information to memory of a portable consumer transaction payment device, wherein the memory of the portable consumer transaction payment device has encoded therein a consumer account for the consumer to engage in a plurality of transactions on the consumer account with a plurality of merchants in a payment processing network, and wherein each said transaction in the payment processing network is submitted by the merchant to an acquirer for processing by a transaction handler who requests an issuer of a corresponding account upon which the transaction was conducted to obtain payment for the transaction from the corresponding account, and wherein the issuer of the corresponding account forwards the payment for the transaction to the transaction handler who forwards the payment for the transaction to the acquirer to reimburse the merchant for the transaction.

13. The method as defined in claim 12, wherein the consumer account is a type of account selected from the group consisting of:
a Flexible Saving Account card account;
a Health Saving Account card account;
a Health Reimbursement Account card account; and
a combination of the foregoing.

14. The method as defined in claim 12, wherein the identifier of the one said free sample is selected from the group consisting of:
a bar code;
a Stock Keeping Unit (SKU);
a Universal Product Code (UPC);
a trademark;
a trade name of a wholesaler;
a trade name of a manufacturer;
an active ingredient of the type of the commodity of the good or service; and
a combination of the foregoing.

15. The method as defined in claim 12, wherein the graphic image for rendering at the POS of the merchant is selected from the group consisting of:
a bar code;
a Universal Product Code (UPC);
an advertisement for a type of a commodity of a good or service;
an advertisement for the merchant;
an advertisement for a provider of the commodity;
an advertisement for a different said commodity also provided the provider of the commodity;
an advertisement for a different said commodity also retailed by the merchant; and
an advertisement for a different said merchant having a retail location proximal to the merchant.

16. The method as defined in claim 12, wherein the memory of the portable consumer transaction payment device is selected from the group consisting of:
a non-volatile memory of a semiconductor device;
a magnetic encoded data region of a magnetic stripe; and
a combination of the foregoing.

17. The method as defined in claim 12, wherein the portable consumer transaction payment device is selected from the group consisting of:
a card having a Radio Frequency Identification (RFID) tag, a transponder device and a microchip; and
a magstripe card; and
a combination of the foregoing.

18. The method as defined in claim 12, wherein the writing to the memory of the portable consumer transaction payment device is performed by a step selected from the group consisting of:
transmitting data wirelessly to the portable consumer transaction payment device;
transmitting data via a hardwired communication to the portable consumer transaction payment device; and
magnetically encoding track data by modifying the magnetism of magnetic particles on a band of magnetic material on the portable consumer transaction payment device.

19. An apparatus comprising:
a user interface to receive a request for a free sample;
a network communication device to:
send the request for the free sample; and
receive an advertising account for a merchant to charge the cost of the free sample for payment to a merchant account to reimburse the merchant for the free sample;
and
a card writer to encode data in memory of the portable consumer transaction payment device, wherein:
the data includes:
the advertising account;
an identifier and a quantity of the free sample;
and
a graphic image for rendering at a Point Of Service terminal (POS) of the merchant;
the memory of the portable consumer transaction payment device includes a consumer account for a consumer to engage in a plurality of transactions on the consumer account with a plurality of said merchants in a payment processing network; and
each said transaction in the payment processing network is submitted by the merchant to an acquirer for processing by a transaction handler who requests an issuer of a corresponding account upon which the transaction was conducted to obtain payment for the transaction from the corresponding account, and wherein the issuer of the corresponding account forwards the payment for the transaction to the transaction handler who forwards the payment for the transaction to the acquirer to reimburse the merchant for the transaction.

20. The apparatus as defined in claim 19, further comprising a card reader for reading consumer data encoded in the memory on the portable consumer transaction payment device.
